(19) United States
(12) Patent Application Publication
(10) Pub. No.: US 2025/0231738 A1
(43) Pub. Date: Jul. 17, 2025

(54) GRAPHICAL USER INTERFACE-BASED INTERACTION WITH INTERACTIVE VOICE RESPONSE SYSTEM

(71) Applicant: Apple Inc., Cupertino, CA (US)

(72) Inventors: Aditya P. TIRTHAHALLI, Tracy, CA (US); Ashwin REVO, Cupertino, CA (US); Gencer CILI, San Jose, CA (US); Yi CHIU, La Jolla, CA (US)

(21) Appl. No.: 19/015,629

(22) Filed: Jan. 9, 2025

Related U.S. Application Data
(60) Provisional application No. 63/620,491, filed on Jan. 12, 2024.

(51) Int. Cl. G06F 3/16; G06F 3/0482; G10L 15/22; G10L 15/26

(52) U.S. Cl. CPC G06F 3/167; G06F 3/0482; G10L 15/22; G10L 15/26

(57) ABSTRACT

Systems and methods provide for communicating with an interactive voice response system using a graphical user interface. An audio stream that includes a voice content is received. The user device transcribes the audio stream. The user device processes the text to identify one or more options included in the voice content of the audio stream. The one or more options are then displayed. The user device receives a selection from the user and transmits an indication of the user selection.

### CROSS REFERENCE TO RELATED APPLICATIONS

This application claims the benefit of U.S. Provisional Application No. 63/620,491, entitled “GRAPHICAL USER INTERFACE-BASED INTERACTION WITH INTERACTIVE VOICE RESPONSE SYSTEM,” filed Jan. 12, 2024, the entirety of which is incorporated herein by reference.

### TECHNICAL FIELD

This disclosure relates to interactive voice response systems (IVRs), including providing a graphical user interface for interacting with an IVR system.

### BACKGROUND

IVR systems are often used by organizations, such as businesses, to provide an automated manner of interacting with users, e.g., customers via telephone. For example, a user may call a phone number associated with an organization and the phone call may be answered by the organization's IVR system. The IVR system may output audio that provides a list of options that the user can select from. The user may select an option by pressing a button on their phone and the IVR may responsively output audio that provides another list of options, and/or may perform some other action, such as forwarding the call to a live operator.

### BRIEF DESCRIPTION OF THE DRAWINGS

Certain features of the subject technology are set forth in the appended claims. However, for the purpose of explanation, several aspects of the subject technology are set forth in the following figures.

FIG. 1 illustrates an example network environment according to aspects of the subject technology.

FIG. 2 illustrates an example computing architecture for a system according to aspects of the subject technology.

FIG. 3 illustrates a flowchart of example interactions with an IVR system using a device that does not provide for graphical user interface-based interactions with the IVR system.

FIG. 4 illustrates an example of interaction between the user and the IVR system using a graphical user interface according to aspects of the subject technology.

FIG. 5A illustrates an example of user interface for displaying the one or more options according to aspects of the subject technology.

FIG. 5B illustrates an example of user interface for displaying the one or more options according to aspects of the subject technology.

FIG. 6 illustrates an example of identifying the operator of the IVR system according to aspects of the subject technology.

FIG. 7 illustrates an example architecture of using a graphical user interface to interact with an IVR system.

FIG. 8 illustrates a flowchart of an example process that may be performed by an electronic device to communicate with a IVR system according to aspects of the subject technology.

FIG. 9 illustrates an example electronic system with which aspects of the subject technology may be implemented in accordance with one or more implementations.

The details above in the Brief Description of the Drawings are intended to describe only some aspects relating to certain embodiments of the innovations herein and should not be deemed in any way limiting with respect to requiring or omitting any aspect for embodiments to be claimed or otherwise limiting the disclosure or embodiments keeping with its scope or spirit.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In some implementations, structures and components are shown in block diagram form to avoid obscuring the concepts of the subject technology.

IVR systems may be used by organizations as a manner of interacting with users in an automated manner, i.e., without needing a human operator. Although the use of IVR systems may be efficient for the organizations, using an IVR system may not necessarily be efficient for users. For example, a user listening to a list of options provided by an IVR system may need to remember each of the options they hear until all of the options are provided. If the user forgets one or more of the options (and/or does not clearly hear one or more of the options), the user may need to re-listen to the entirety of the options from the beginning which may waste the user's time as well as processing, power, and communication resources. In some instances, the user may not speak the language that is used by the IVR system, and therefore may be unable to understand the provided menu options or effectively interact with the IVR system.

In the subject system, the user's device may be configured to transcribe the audio options provided by an IVR system and generate and display a graphical user interface that allows the user to view the audio options as transcribed text and select from the displayed options. For example, the user can select a displayed option via the graphical user interface, such as by touching a displayed option, and the subject system may provide an indication of the selected option back to the IVR system. The IVR system may then responsively provide a second list of options and the subject system may transcribe the provided options and update the displayed graphical user interface to include the second list of options. In one or more implementations, the subject system may also be able to translate from the language of the IVR into the language used by the user, thereby allowing the user to interact with the IVR system without any language barriers.

Thus, the subject system provides a graphical user interface for interacting with an IVR system in real-time thereby allowing for more efficient user interactions with IVR systems by supplementing the default IVR audio options with visual options provided by the graphical user interface. Accordingly, the subject system may provide improvements in processing, memory, and communication resource usage when a user is interacting with an IVR system by providing for more efficient and streamlined IVR interactions.

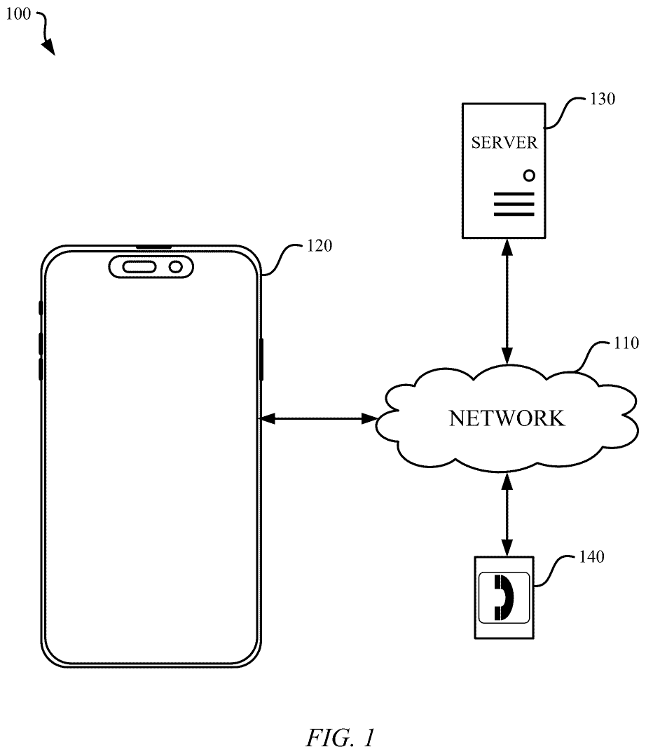

FIG. 1 illustrates an example network environment 100 according to aspects of the subject technology. Not all the depicted components may be used in all implementations, however, and some implementations may include additional or different components than those shown in the figure. Variations in the arrangement and type of the components may be made without departing from the scope of the claims as set forth herein. Additional components, different components, or fewer components may be provided.

The network environment 100 includes a user device 120, a server 130 and a IVR system 140 connected via a network 110. The network 110 may communicatively (directly or indirectly) couple the server 130 and the user devices 120. The network 110 is not limited to any particular type of network, network topology, or network media. The network 110 may be a local area network (LAN) or a wide area network (WAN) and may include and/or may be communicatively coupled to a telecommunications network. The network 110 may be an interconnected network of devices that may include or may be communicatively coupled to the Internet. For explanatory purposes, the network environment 100 is illustrated in FIG. 1 as including the user device 120, the server 130 and IVR system 140. However, the network environment 100 may include any number of user devices, servers, IVR systems and/or other computing/networking devices.

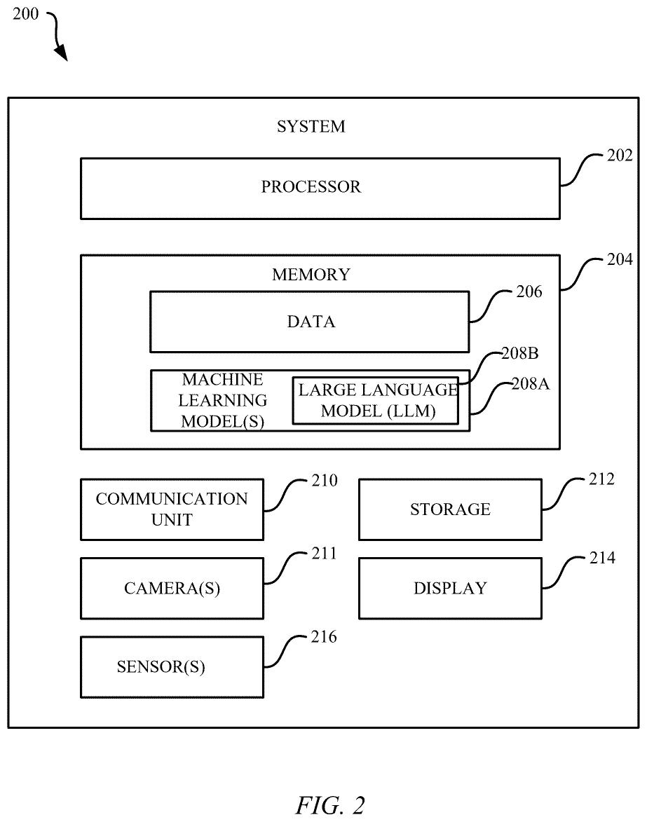

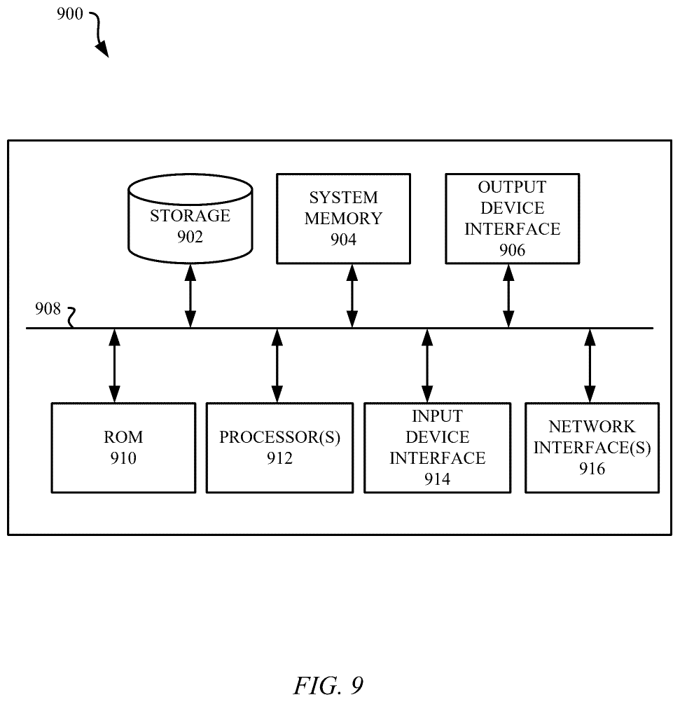

The user device 120 may be, for example, a desktop computer, a portable computing device such as a laptop computer, a smartphone, a peripheral device (e.g., a digital camera, headphones), a tablet device, a wearable device such as a watch, a band, and the like. In FIG. 1, by way of example, the user device 120 is depicted as a smartphone. The user device 120 may be, and/or may include all or part of, the systems discussed below with respect to FIG. 2 and/or with respect to FIG. 9.

In some implementations, the user device 120 may provide a system for training a machine learning model using training data, where the trained machine learning model is subsequently deployed locally at the user device 120. Further, the user device 120 may provide one or more frameworks for training machine learning models and/or developing applications using the machine learning models. In an example, the user device 120 may be an electronic device (e.g., a smartphone, a tablet device, a laptop computer, a desktop computer, a wearable electronic device, etc.) that can be used to communicate with entities like friends, family, colleagues, customer care support, IVR systems, etc.

In some implementations, a server 130 may provide a platform to train one or more machine learning models for deployment to the user device 120. The machine learning models deployed on the user device 120 may then perform one or more machine learning tasks. In some implementations, the server 130 may provide a cloud service that utilizes the trained machine learning model and is continually refined over time. The server 130 may be, and/or may include all or part of, the systems discussed below with respect to FIG. 2 and/or with respect to FIG. 9.

The IVR system 140 may be, and/or may include, one or more computing and/or telephony devices that are communicatively coupled to the network 110 and/or one or more other networks or telecommunication systems. The IVR system 140 may be configured to receive a telephone call, e.g., via a telecommunications network, and output audio prompts and/or responses (e.g., pre-recorded or dynamically generated) to a user over the telephone call. Each of the audio prompts may be associated with a dual-tone multi-frequency signaling (DTMF) tone that may be actuated by a user by pressing a corresponding button on their telephone, e.g., ‘1’, ‘2’, ‘3’, etc., which may be relayed to the IVR system 140. The IVR system 140 may responsively perform an action, e.g., outputting additional audio prompts, in response to receiving a DTMF tone. The IVR system 140 may also be configured to receive audio inputs from a user, such as spoken words. The IVR system 140 may be and/or may include all or part of the system discussed below with respect to FIG. 9.

FIG. 2 illustrates an example system 200 in accordance with some implementations of the subject technology. In an example, the system 200 may be implemented in the user device 120 or the server 130. In another example, the system 200 may be implemented either in a single device or in a distributed manner in a plurality of devices, the implementation of which would be apparent to a person skilled in the art.

In an example, the system 200 may include a processor 202, memory 204 (memory device) and a communication unit 210. The memory 204 may store data 206 and one or more machine learning models 208A. In an example, the system 200 may include or may be communicatively coupled with a storage 212. Thus, the storage 212 may be either an internal storage or an external storage. In the example of FIG. 2, the system 200 includes one or more camera(s) 211, a display 214, and one or more sensors(s) 216. Sensor(s) 216 may include location sensors (e.g., satellite positioning system sensors), motion sensors (e.g., inertial sensors), and/or depth sensors (e.g., stereo cameras, LIDAR sensors, radar sensors, time-of-flight sensors, or the like).

In an example, the processor 202 may be a single processing unit or multiple processing units. The processor 202 may be implemented as one or more microprocessors, microcomputers, microcontrollers, digital signal processors, central processing units (CPUs), graphics processing units (GPUs), neural processors, specialized processors, e.g., for training and/or evaluating machine learning models, such as large language models, state machines, logic circuitries, and/or any devices that manipulate signals based on operational instructions. Among other capabilities, the processor 202 is configured to fetch and execute computer-readable instructions and data stored in the memory 204.

The memory 204 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The data 206 may represent, amongst other things, a repository of data processed, received, and generated by one or more processors such as the processor 202. One or more of the aforementioned components of the system 200 may send or receive data, for example, using one or more input/output ports and one or more communication units.

The machine learning model(s) 208A, in an example, may include one or more of machine learning based models, artificial intelligence-based models, and/or large language models 208B. In an example, the machine learning model(s) 208A may be trained using training data (e.g., included in the data 206 or other data) and may be implemented by the processor 202 for performing one or more of the operations, as described herein.

In an example, the communication unit 210 may include one or more hardware units that support wired or wireless communication between the processor 202 and processors of other computing devices, and/or for communication over a telecommunication network.

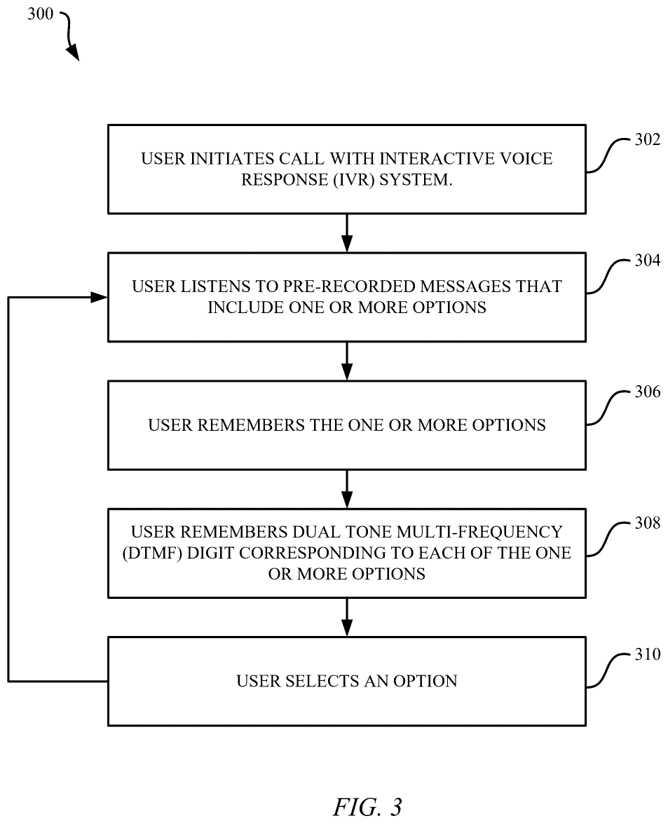

FIG. 3 illustrates a flowchart of an example process 300 for interacting with an IVR system using a device that does not provide for graphical user interface-based interactions with the IVR system. For explanatory purposes, the process 300 is primarily described herein with reference to the user device 120 of FIG. 1. However, the process 300 is not limited to the user device 120 of FIG. 1, and one or more blocks (or operations) of the process 300 may be performed by one or more other suitable devices. Further for explanatory purposes, the blocks of the process 300 are described herein as occurring in serial, or linearly. However, multiple blocks of the process 300 may occur in parallel. In addition, the blocks of the process 300 need not be performed in the order shown and/or one or more blocks of the process 300 need not be performed and/or can be replaced by other operations.

At block 302, the user uses the user device 120 to initiate an outgoing call with the IVR system 140. For example, the user can dial a phone number associated with the IVR system 140 or may receive an incoming call from the IVR system 140. At block 304, the IVR system 140 transmits pre-recorded messages in response to receiving the user's call. These pre-recorded messages are transmitted as an audio stream and may include one or more options or prompts.

For example, an audio message may state “Press 1 for Option A, Press 2 for Option B, Press 3 for Option C.” At block 306, the user remembers the one or more options provided by the IVR system 140. In this example, the user has to remember Options A, B, and C. At block 308, the user remembers the Dual Tone Multi-Frequency (DTMF) digit associated with the one or more options. In this example, the user has to remember that the user has to select digit 1 for Option A, digit 2 for Option B and digit 3 for Option C. At block 310, the user interacts with the digital keypad of the user device 120 to make a selection, such as after the IVR system 140 has completed outputting the various options. For example, if the user selects Option B, the user performs a touch interaction with the digit 2 displayed on the digital keypad and/or may speak the number “2”. After selecting an option, a DTMF signal and/or tone is transmitted back to the IVR system 140. The IVR system 140 can process the DTMF signal to determine the user's selection. In response, determining the user's selection, the IVR system 140 may transmit another audio message to the user device 120, and/or may perform some other action such as transferring the call to a human operator.

FIG. 3 highlights the inefficiencies that a user may encounter while interacting with an IVR system. For example, at block 306, the user has to remember the one or more options provided by the IVR system 140 which may become increasingly difficult as the number of options increases. Similarly, at block 308, the user has to remember the DTMF digits associated with the one or more options. In addition, if the user has difficulty in hearing and/or understanding any part of the audio message, the audio message may need to be repeated by the IVR system 140 in its entirety. Similarly, if the IVR system 140 does not support or provide audio messages in the user's spoken language, the user may be unable to understand the audio messages.

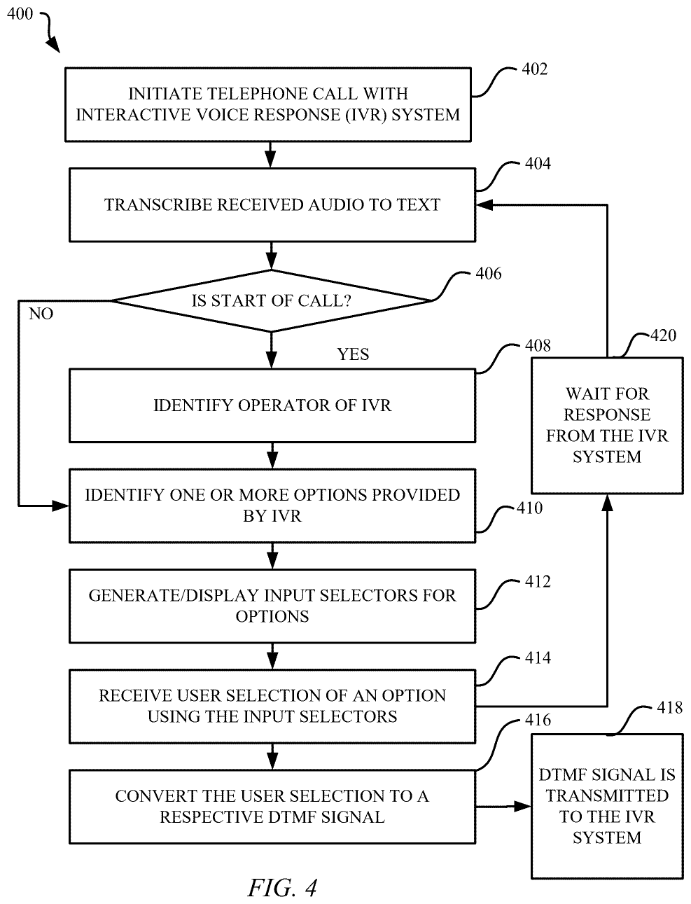

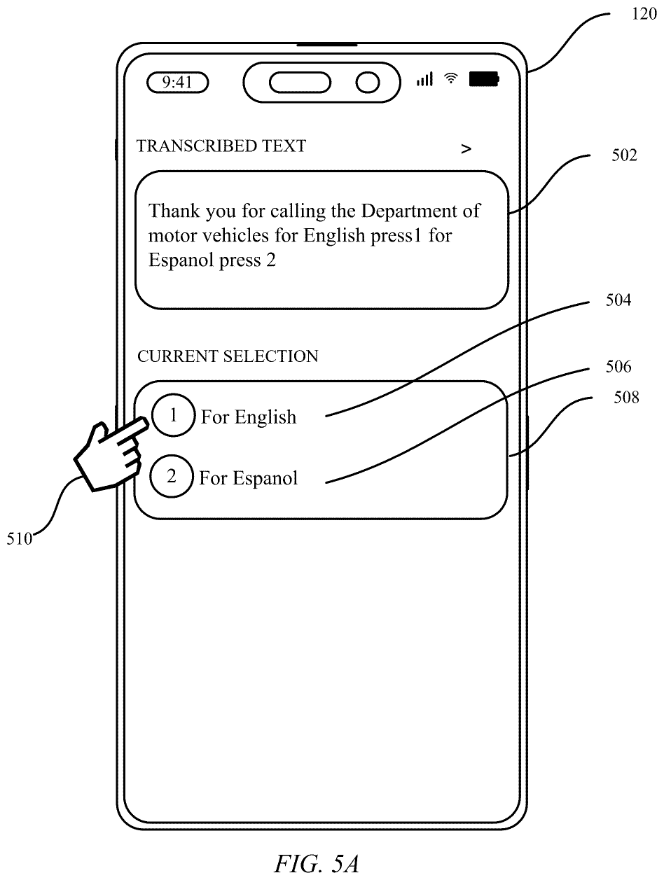

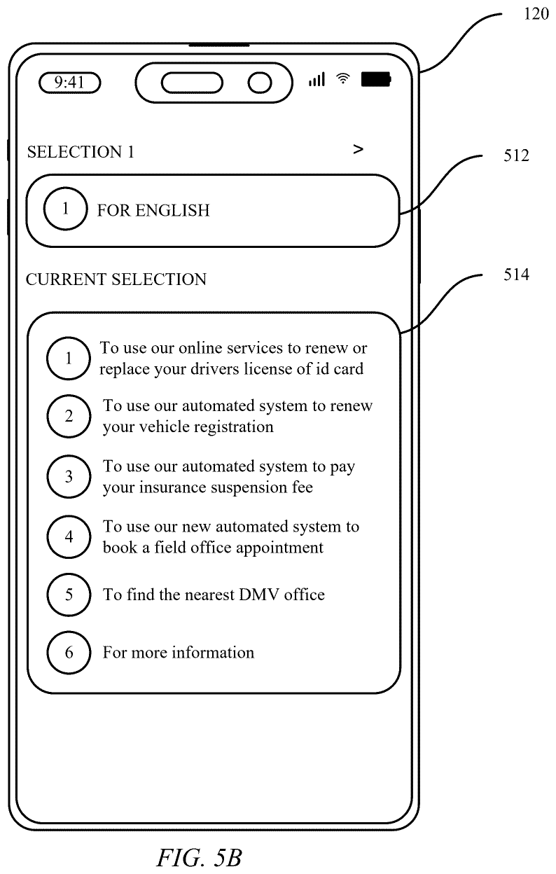

The subject system solves these and other problems by providing a graphical user interface for interacting with the IVR system 140, such as separately or in addition to interacting with the IVR system 140 through the audio prompts, which is discussed further below with respect to FIGS. 4 and 5.

FIG. 4 is a flowchart illustrating an example process 400 of interacting with an IVR system using a user device 120 that supports graphical user interface-based interactions with the IVR system. For explanatory purposes, the process 400 is primarily described herein with reference to the user device 120 of FIG. 1. However, the process 400 is not limited to the user device 120 of FIG. 1, and one or more blocks (or operations) of the process 400 may be performed by one or more other suitable devices. Further for explanatory purposes, the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations.

At block 402, the user device 120 initiates a telephone call with an IVR system 140. For example, a user may use the user device 120 to dial a telephone number associated with the IVR system 140. In another example, the user device 120 may receive an incoming call from the IVR system 140.

At block 404, the user device 120 receives one or more audio messages from the IVR system and transcribes the received audio messages into text. The audio messages may be, for example, pre-recorded and/or dynamically generated and may be transmitted as an audio stream. The audio messages may include voice content that describes one or more options provided by the IVR system 140. For example, an audio message may state “Press 1 for Option A, Press 2 for Option B, Press 3 for Option C.” As for another example, a message may state “Please wait until the call is transferred.” The user device 120 may use a machine learning model to process the audio stream to transcribe the voice of the audio stream into text. The machine learning model can be any machine learning model and is not limited to any particular type. For example, the first machine learning model can be a Hidden Markov models (HMM) or a deep learning-based speech recognition acoustic model that is trained to transcribe speech to text.

At block 406, the user device 120 determines whether the text transcribed at block 404 corresponds to the start of a call or corresponds to a continuation of an ongoing call. For example, text corresponding to the start of a call may include one or more pleasantries such as, “hello,” “good day,” “welcome,” etc. If the transcribed text corresponds to the start of the call, the user device 120 moves to block 408. If the transcribed text corresponds to an ongoing call, the user device 120 moves to block 410.

At block 408, the user device 120 identifies an operator of the IVR system 140 based on the text transcribed at block 404. For example, the user device 120 can process the transcribed text from block 404 using a second machine learning model to generate one or more segments. In some implementations, the second machine learning model can use one or more NLP techniques including Named Entity Recognition (NER), Count Vectorizer, TF-IDF, bag of words, bag of n-grams, etc. In some implementations, segments can refer to sentences. For example, assume that a transcribed text from block 404 is “Welcome to First Class Bank. For security purposes this call will be recorded. Please hold the line for the next available slot. Current wait time is 30 seconds.” In this example, the user device 120 can process the transcribed text using the second machine learning model to identify one or more sentences. For example, the first segment can be “Welcome to First Class Bank.” Similarly, the second segment can be “For security purposes this call will be recorded.”

In some implementations, segments can also refer to n-grams or keywords such as nouns or phrases. For example, the user device 120 can process the transcribed text using the second machine learning model to identify one or more keywords. For example, a keyword can be “First Class Bank.”

In some implementations, the user device 120 can further process the one or more segments using a third machine learning model to generate a second set of features to determine identity of the operator of the IVR system 140. The third machine learning model can be any machine learning model and is not limited to any particular type. For example, the third machine learning model can be a neural network-based machine learning model such as an autoencoder. In some implementations, the third machine learning model can use one or more NLP techniques including Count Vectorizer, TF-IDF, word embeddings, bag of words, bag of n-grams, Hashing Vectorizer, Latent Dirichlet Allocation (LDA), Non-negative Matrix Factorization (NMF), Principal Component Analysis (PCA), t-SNE, and Part-of-Speech (POS) tagging.

In some implementations, the user device 120 can process the second set of features using a machine learning model that is trained to identify the operator of IVR based on the set of features. For example, assume that the transcribed text from the block 404 is “Welcome to First Class Bank. For security purposes this call will be recorded. Please hold the line for the next available slot. Current wait time is 30 seconds.” Further assume that the keyword determined by the second machine learning model is “First Class Bank.” In this example, the user device 120 can identify the First-Class Bank as the operator of the IVR system 140.

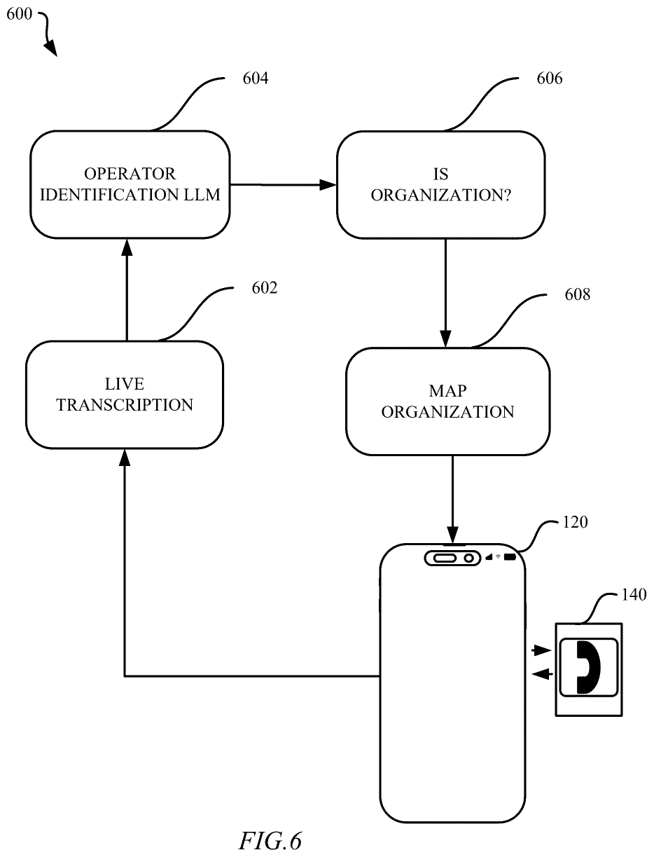

In some implementations, the second machine learning model can be a large language model (referred to as an operator recognition LLM). The operator recognition LLM can be a deep learning models with an underlying transformer architecture consisting of encoder, decoder, self-attention capabilities and a plurality of trainable parameters. In such implementations, the user device 120 can process the transcribed text from block 404 to identify the operator. This is further explained with reference to FIG. 6.

At block 410, the user device 120 identifies the one or more options provided by the IVR system 140. For example, the user device 120 can process the transcribed text from block 404 using the second machine learning model to generate and/or identify one or more segments that correspond to the one or more options. These segments can refer to sentences, n-grams, or keywords such as nouns or phrases. For example, assume that a transcribed text from block 404 is “Press 1 for Option A, Press 2 for Option B, Press 3 for Option C.” In this example, the user device 120 can process the transcribed text using the second machine learning model to identify one or more segments. For example, the first segment can be “Press 1 for Option A.” Similarly, the second segment can be “Press 2 for Option B.”

In some implementations, the user device 120 can further process the one or more segments using a third machine learning model to generate a first set of features. The third machine learning model can be any machine learning model and is not limited to any particular type. The user device 120 can further process the first set of features to identify the one or more options. For example, the user device 120 can process the second set of features using a machine learning model such as a large language model (LLM) to identify the one or more options.

In general, LLMs may be deep learning models with an underlying transformer architecture consisting of encoder, decoder, self-attention capabilities and a plurality of trainable parameters. The LLM can be trained on a training dataset that includes multiple training samples. Each training sample can be a pair that includes (1) a second set of features extracted from the one or more segments and, (2) one or options corresponding to the one or more segments (e.g., annotated by the humans or a superior machine learning model.)

In some implementations, the third machine learning model can be a large language model (referred to as an option identification LLM). The option identification LLM can be a deep learning models with an underlying transformer architecture consisting of encoder, decoder, self-attention capabilities and a plurality of trainable parameters. In such implementations, the user device 120 can process the transcribed text from block 404 to identify the one or more options. In such implementations, the option identification LLM can be trained on a training dataset that includes multiple training samples. Each training sample can be a pair that includes (1) a text and, (2) one or options corresponding to the text (e.g., annotated by the humans or a superior machine learning model.)

In some implementations, the LLM can generate the one or more options sequentially. For example, as soon as the IVR system 140 starts to transmit the audio stream, the user device 120 can transcribe the voice in the audio stream to generate text. As the text is being generated, the user device 120 can use the third machine learning model to generate the one or more options sequentially. Simultaneously, the user device 120 can start storing the one or more options in the memory 204 and the storage 212. In some embodiments, the user device 120 can further use the third machine learning model to generate a summarized version of the one or more options, which are then displayed on the user device 120. For example, if an option is too long to fit into the display 214 of the user device 120, the user device 120 can use the third machine learning model to generate a summarized version of the option which can be displayed on the display 214 of the user device 120. The user device 120 can start displaying the one or more options to the user using the display 214 of the user device 120. Continuing with the example provided above, the user device 120 can process the one or more segments using the LLMs to determine Option A, B and C and the corresponding DTMF digits 1, 2 and 3, respectively.

At block 412, the user device 120 determines the input selectors for the one or more options. Input selectors provide a mechanism for the user to select an option as expected by the IVR system 140. For example, the IVR system 140 can provide 5 options to the user and expects the user to interact with DTMF digits 1-5 of the keypad for selecting an option. As for another example, the IVR system 140 can expect the user to enter the user's phone number via the keypad. As for another example, the IVR system 140 can expect the user to enter the user's name via speech or via keyboard. A selector for selecting a DTMF digit is one form of input selectors. Other forms of input selectors can include speech, obtaining a selection from the keypad, a dropdown list, a checkbox, or generally any input mechanism that may be displayed on a graphical user interface.

In some implementations, the user device 120 can use a machine learning model such as a classifier to process the one or more options to determine the action requested by the IVR system 140. In some implementations, the classifier is a LLM that is fine tuned to classify each of the one or more options to the corresponding actions. For example, if the total number of unique actions for selecting options is 13 (0-9 digits, keypad, speech, and no action), the classification model can generate 13 classes as output. In some implementations, the classifier can include six transformer blocks and 66 million parameters.

At block 414, the user can select, e.g., touch, one of the options displayed on the user device 120 to select the option.

At block 416, the user device 120 converts the user selection to one or more respective DTMF signals. For example, while generating the one or more options via the LLM and displaying them on the user device, the user device 120 can map each of the options among the one or more options to a corresponding input selector requested by the IVR system 140. For example, a typical message from the IVR system 140 can say “Press 1 for Option A, Press 2 for Option B, Press 3 for Option C.” In this example, the IVR system 140 expects the user to interact with digit 1 on the keypad of the user device 120 to select option A. Similarly, the IVR system 140 expects the user to interact with digits 2 and 3 on the keypad of the user device 120 to select option B and option C, respectively. When the user selects a particular option via touch interaction, the user device 120 can use the map to determine the digit expected by the IVR system 140 for the particular option. The user device 120 can then generate a signal with a frequency associated with the digit according to the DTMF signaling protocol.

At block 418, the user device 120 transmits the generated signal to the IVR system 140 via the network 110, such as via a telecommunications network and/or via a data network.

At block 420, the user device 120 waits for a response from the IVR system 140, such as with a second message with one or more second options. For example, the IVR system 140 after receiving the user selection from the user device 120, can send a second message i.e., a second audio stream that includes a second voice content. Blocks 410-420 are explained with reference to FIG. 5A and FIG. 5 B.

FIG. 5A is an example of graphical user interface provided on the user device 120 illustrating one or more options and the input selectors for interacting with the IVR system 140. FIG. 5A shows the user device 120 calling the Department of Motor Vehicles (DMV). When the call starts, the user device 120 receives an audio stream with voice content from the IVR system 140 of the DMV. User interface element 502 shows the transcribed text generated by the user device 120 using the first machine learning model. The user device 120 uses the second machine learning model to generate one or more segments and the third machine learning model to generate a second set of features. The user device 120 then uses the LLM to generate the two options 504 and 506 in the current selection 508. FIG. 5A further shows the user selection 510 of option “For English.”

FIG. 5B is another example of a graphical user interface of the user device 120 illustrating the one or more options and the input selectors for interacting with the IVR system 140. User interface element 512 shows the prior user selection from FIG. 5A. After selecting the option “For English.” in FIG. 5A, the user device 120 can use the map to determine the digit expected by the IVR system 140 for the particular option. The user device 120 can then generate a signal with a frequency associated with the digit according to the DTMF signaling protocol. In response to receiving the signal, the IVR system 140 may, for example, transmit a second audio stream to provide one or more second options. The user device 120 uses the second machine learning model to generate one or more second segments. The user device 120 then uses the third machine learning model to generate the one or more second options. The user device 120 can also use the third machine learning model to generate a summarized version of the one or more second options, which are then displayed on the user device 120. The one or more second options are then displayed to the user on the user device 120. User interface element 514 shows the one or more second options being displayed on the user deice 120.

FIG. 6 illustrates a block diagram 600 of identifying an operator of the IVR system 140. The user device 120 initiates a call with the IVR system 140. For example, the user uses the user device 120 to initiate an outgoing call with an IVR system 140. The IVR system 140 transmits pre-recorded audio messages to the user device 120. These messages are transmitted to the user device 120 as an audio stream. At block 602, the user device 120 can use a first machine learning model to process the audio stream to transcribe the voice of the audio stream into text. At block 604, the user device 120 uses operator identification LLM to process the transcribed text. At block 606, the user device 120 determines whether the operator identification LLM successfully determined an operator of the IVR system 140. At block 608, and after successfully determining the operator, the user device 120 generates a record of the operator and stores the record in the memory 204 and the storage 212. The record can include the name of the operator, the phone number of the IVR system 140, a list of messages received from the IVR system 140 and for each of the messages, a corresponding list of one or more options. In some implementations, the record can be used later to identify the operator of the IVR system 140 and also to identify the one or more options provided by the IVR system 140. In some implementations, the record can also be shared with other users.

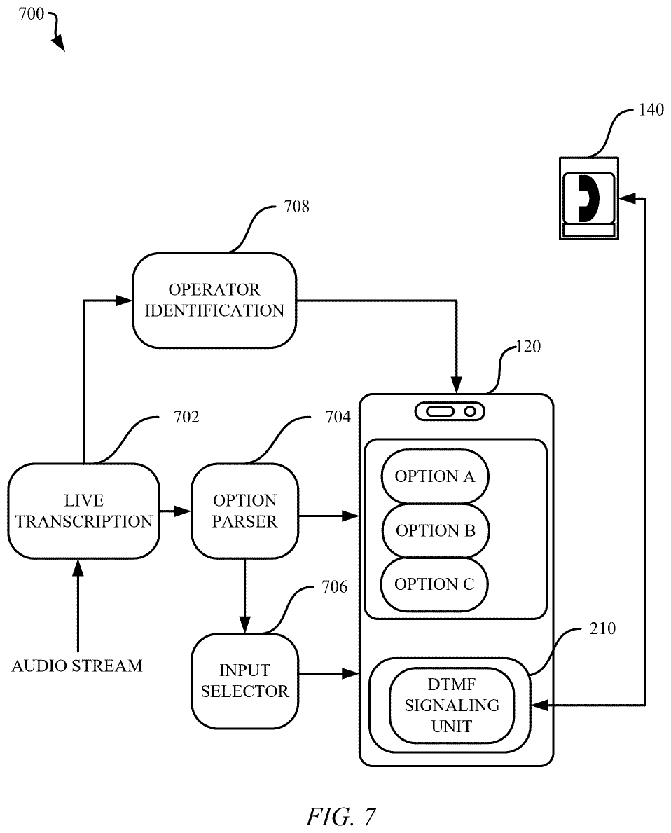

FIG. 7 illustrates an example architecture 700 for using a graphical user interface to interact with an IVR system. At block 702, the user device 120 processes an audio stream received from the IVR system 140 using the first machine learning model to generate text. At block 704, the user device 120 identifies the one or more options in the audio stream provided by the IVR system 140. At block 706, the user device 120 identifies one or more input selectors corresponding to the one or more options. At block 708, the user device 120 processes the transcribed text to identity the operator of the IVR system 140. The user device 120 then displays the one or more options determined at block 704. When the user of the user device 120 selects an option from among the one or more options, the user device 120 maps the user selection to the corresponding DTMF digit(s) expected by the IVR system 140. The user device 120 provides the corresponding DTMF digit(s) to the communications unit 210 of the user device 120 that includes a DTMF signaling unit. The DTMF signaling unit transmits a signal with a specific frequency to the IVR system 140. For example, the frequency of the signal may be based on the DTMF digit(s) provided to the communications unit 210. In some implementations, the user device 120 can communicate a sequence of DTMF signaling protocol signals to indicate string data (e.g., name, phone number, etc.,) to the IVR system 140.

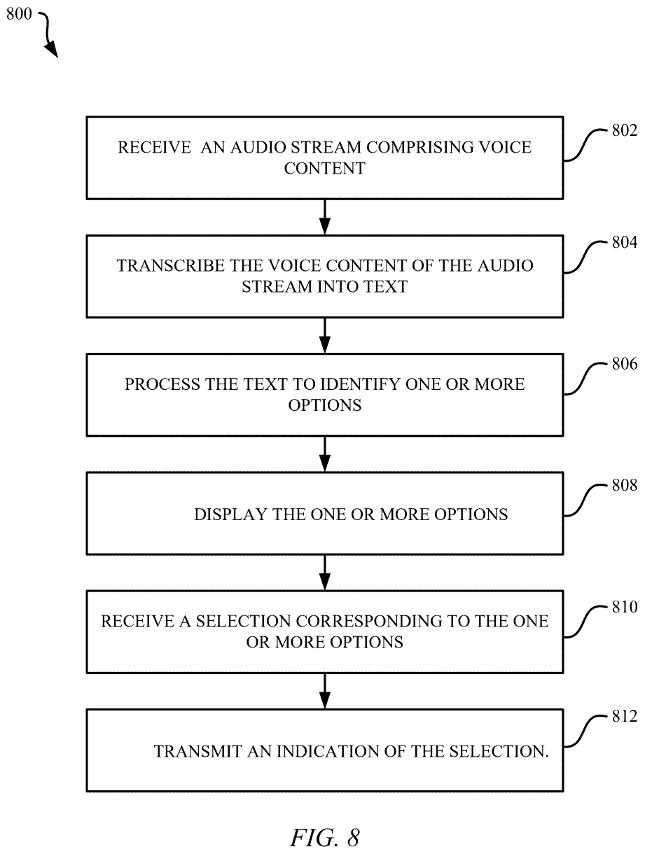

FIG. 8 illustrates a flow diagram of an example process 800 performed by a user device 120 to interact with the IVR system 140 using a graphical user interface. For explanatory purposes, the process 800 is primarily described herein with reference to the user device 120 of FIG. 1. However, the process 800 is not limited to the user device 120 of FIG. 1, and one or more blocks (or operations) of the process 800 may be performed by one or more other suitable devices. Further for explanatory purposes, the blocks of the process 800 are described herein as occurring in serial, or linearly. However, multiple blocks of the process 800 may occur in parallel. In addition, the blocks of the process 800 need not be performed in the order shown and/or one or more blocks of the process 800 need not be performed and/or can be replaced by other operations.

At block 802, the user device 120 receives an audio stream comprising voice content from an IVR system 140. For example, the user uses the user device 120 to initiate an outgoing call with an IVR system 140. For example, the user can dial a phone number associated with the IVR system 140. As for another example, the user device 120 may receive an incoming call from the IVR system 140.

At block 804, the user device 120 transcribes the voice content of the audio stream into text. For example, the user device 120 can use a first machine learning model to process the audio stream to transcribe the voice of the audio stream into text. The first machine learning model can be any machine learning model and is not limited to any particular type. For example, the first machine learning model can be a Hidden Markov models (HMM) or a deep learning-based speech recognition acoustic model.

At block 806, the user device 120 processes the text to identify one or more options. For example, the user device 120 can process the transcribed text using the second machine learning model to generate one or more segments. These segments can refer to sentences, n-grams, or keywords such as nouns or phrases.

The user device 120 can further process the one or more segments using a third machine learning model to generate a first set of features. The third machine learning model can be any machine learning model and is not limited to any particular type. The user device 120 can further process the first set of features to identify the one or more options. For example, the user device 120 can process the second set of features using a machine learning model such as a large language model (LLM) to identify the one or more options.

The third machine learning model can be a large language model (referred to as an option identification LLM). The option identification LLM can be a deep learning models with an underlying transformer architecture consisting of encoder, decoder, self-attention capabilities and a plurality of trainable parameters. The user device 120 can process the transcribed text to identify the one or more options. In such implementations, the option identification LLM can be trained on a training dataset that includes multiple training samples. Each training sample can be a pair that includes (1) a text and, (2) one or options corresponding to the text (e.g., annotated by the humans or a superior machine learning model.)

The LLM can generate the one or more option sequentially. For example, as soon as the IVR system 140 starts to transmit the audio stream, the user device 120 can transcribe the voice in the audio stream to generate text. As the text is being generated, the user device 120 can use the third machine learning model to generate the one or more options sequentially. Simultaneously, the user device 120 can start storing the one or more options in the memory 204 and the storage 212. The user device 120 can also use the third machine learning model to generate a summarized version of the one or more options, which are then displayed on the user device 120.

At block 808, the user device 120 displays the one or more options. For example, the user device 120 can start displaying the one or more options to the user using the display 214 of the user device 120.

At block 810, the user device 120 receives a selection corresponding to the one or more options. For example, the user can touch one of the options displayed on the user device 120 to select the option.

At block 812, the system transmits an indication of the selection to the IVR system 140. For example, when the user selects a particular option via touch interaction, the user device 120 can use the map to determine the DTMF digit expected by the IVR system 140 for the particular option. The user device 120 can then transmit the DTMF digit to the communications unit 210. The communications unit 210 generates a signal and/or tone with a frequency associated with the DTMF digit according to the DTMF signaling protocol and transmits the signal to the IVR system 140.

As described above, one aspect of the present technology is the gathering and use of data available from specific and legitimate sources for providing a graphical user interface for interacting with an IVR system. The present disclosure contemplates that in some instances, this gathered data may include personal information data that uniquely identifies or can be used to identify a specific person. Such personal information data can include audio data, voice samples, voice profiles, demographic data, location-based data, online identifiers, telephone numbers, email addresses, home addresses, biometric data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used for providing a graphical user interface for interacting with an IVR system.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the example of providing a graphical user interface for interacting with an IVR system, the present technology can be configured to allow users to select to “opt in” or “opt out” of participation in the collection and/or sharing of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level or at a scale that is insufficient for facial recognition), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

FIG. 9 illustrates an electronic system 900 with which one or more implementations of the subject technology may be implemented. The electronic system 900 can be, and/or can be a part of, server 130 and/or user device 120 shown in FIG. 1. The electronic system 900 may include various types of computer readable media and interfaces for various other types of computer readable media. The electronic system 900 includes a bus 908, one or more processing unit(s) 912, a system memory 904 (and/or buffer), a ROM 910, a permanent storage device 902, an input device interface 914, an output device interface 906, and one or more network interfaces 916, or subsets and variations thereof.

The bus 908 collectively represents all system, peripheral, and chipset buses that communicatively connect the numerous internal devices of the electronic system 900. In one or more implementations, the bus 908 communicatively connects the one or more processing unit(s) 912 with the ROM 910, the system memory 904, and the permanent storage device 902. From these various memory units, the one or more processing unit(s) 912 retrieves instructions to execute and data to process in order to execute the processes of the subject disclosure. The one or more processing unit(s) 912 can be a single processor or a multi-core processor in different implementations.

The ROM 910 stores static data and instructions that are needed by the one or more processing unit(s) 912 and other modules of the electronic system 900. The permanent storage device 902, on the other hand, may be a read-and-write memory device. The permanent storage device 902 may be a non-volatile memory unit that stores instructions and data even when the electronic system 900 is off. In one or more implementations, a mass-storage device (such as a magnetic or optical disk and its corresponding disk drive) may be used as the permanent storage device 902.

In one or more implementations, a removable storage device (such as a floppy disk, flash drive, and its corresponding disk drive) may be used as the permanent storage device 902. Like the permanent storage device 902, the system memory 904 may be a read-and-write memory device. However, unlike the permanent storage device 902, the system memory 904 may be a volatile read-and-write memory, such as random-access memory. The system memory 904 may store any of the instructions and data that one or more processing unit(s) 912 may need at runtime. In one or more implementations, the processes of the subject disclosure are stored in the system memory 904, the permanent storage device 902, and/or the ROM 910. From these various memory units, the one or more processing unit(s) 912 retrieves instructions to execute and data to process in order to execute the processes of one or more implementations.

The bus 908 also connects to the input and output device interfaces 914 and 906. The input device interface 914 enables a user to communicate information and select commands to the electronic system 900. Input devices that may be used with the input device interface 914 may include, for example, alphanumeric keyboards and pointing devices (also called “cursor control devices”). The output device interface 906 may enable, for example, the display of images generated by electronic system 900. Output devices that may be used with the output device interface 906 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 9, the bus 908 also couples the electronic system 900 to one or more networks and/or to one or more network nodes, such as the user device 120 shown in FIG. 1, through the one or more network interface(s) 916. In this manner, the electronic system 900 can be a part of a network of computers (such as a LAN, a wide area network (“WAN”), or an Intranet, or a network of networks, such as the Internet. Any or all components of the electronic system 900 can be used in conjunction with the subject disclosure.

Implementations within the scope of the present disclosure can be partially or entirely realized as computer program products comprising code in a tangible computer-readable storage medium (or multiple tangible computer-readable storage media of one or more types) encoding one or more instructions of the code. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non- executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or segmented in a different way) all without departing from the scope of the subject technology.

Aspects of the present technology may include the gathering and use of data available from specific and legitimate sources to train machine learning models and to apply to trained machine learning models deployed in systems. The present disclosure contemplates that in some instances, this gathered data may include personal information data that uniquely identifies or can be used to identify a specific person. Such personal information data can include meta-data or other data associated with images that may include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to train a machine learning model for better performance. Accordingly, use of such personal information data enables users to have greater control of the delivered content. Further, other uses for personal information data that benefit the user are also contemplated by the present disclosure.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are recognized as meeting or exceeding industry or governmental requirements for maintaining the privacy of users. Such information regarding the use of personal data should be prominently and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of training data collection, the present technology can be configured to allow users to select to “opt in” or “opt out” of participation in the collection of personal information data during registration for services or anytime thereafter. In another example, users can select not to provide mood-associated data for use as training data. In yet another example, users can select to limit the length of time mood-associated data is maintained or entirely block the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, training data can be selected based on aggregated non-personal information data or a bare minimum amount of personal information, such as the content being handled only on the user's device or other non-personal information available to as training data.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can be integrated together in a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation, or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A computer-implemented method comprising:
receiving, over a communication channel, an audio stream comprising voice content;
transcribing the voice content of the audio stream into text;
processing the text to identify one or more options included in the voice content of the audio stream;
displaying the one or more options;
receiving a selection corresponding to the one or more options; and
transmitting, over the communication channel, an indication of the selection.

2. The computer-implemented method of claim 1, further comprising:
storing the one or more options;
receiving, over the communication channel, a second audio stream comprising a second voice content in response to transmitting the indication of the selection;
transcribing the second voice content of the second audio stream into a second text;
processing the second text to identify one or more second options included in the second voice content of the second audio stream; and
displaying the one or more second options.

3. The computer-implemented method of claim 2, further comprising displaying the one or more options if the second audio stream comprising the second voice content is substantially the same as the audio stream comprising the voice content.

4. The computer-implemented method of claim 1, further comprising:
establishing the communication channel by accepting an inbound communication request or transmitting an outbound communication request.

5. The computer-implemented method of claim 1, wherein transcribing the voice content of the audio stream comprises processing the voice content of the audio stream using a first machine learning model to generate the text.

6. The computer-implemented method of claim 1, further comprising determining, based at least in part on at least a portion of the audio stream, whether the voice content corresponds to an interactive voice response system.

7. The computer-implemented method of claim 6, wherein processing the text comprises:
processing the text using a second machine learning model to generate one or more segments;
extracting a first set of features and a second set of features from the one or more segments using a third machine learning model;
identifying the one or more options using the first set of features; and
identifying an entity based on the second set of features, wherein the entity corresponds to an operator of the interactive voice response system.

8. The computer-implemented method of claim 7, wherein in response to identifying that the entity corresponds to the operator of the interactive voice response system, generating and storing an association between the one or more options and the entity.

9. The computer-implemented method of claim 1, wherein displaying the one or more options further comprises:
identifying one or more input selectors for receiving the selection; and
displaying the one or more input selectors in association with the one or more options.

10. The computer-implemented method of claim 1, wherein the selection corresponding to the one or more options is received via at least one of an audio interface or a keyboard interface.

11. A device, comprising:
a memory; and
a processor configured to:
receive, over a communication channel, an audio stream comprising voice content;
transcribe the voice content of the audio stream into text;
process the text to identify one or more options included in the voice content of the audio stream;
display the one or more options;
receive a selection corresponding to the one or more options; and
transmit, over the communication channel, an indication of the selection.

12. The device of claim 11, wherein the processor is further configured to:
store the one or more options;
receive, over the communication channel, a second audio stream comprising a second voice content in response to transmitting the indication of the selection;
transcribe the second voice content of the second audio stream into a second text;
process the second text to identify one or more second options included in the second voice content of the second audio stream; and
display the one or more second options.

13. The device of claim 12, wherein the processor is further configured to display the one or more options if the second audio stream comprising the second voice content is substantially the same as the audio stream comprising the voice content.

14. The device of claim 11, wherein the processor is further configured to:
establish the communication channel by accepting an inbound communication request or transmitting an outbound communication request.

15. The device of claim 11, wherein the processor is configured to transcribe the voice content of the audio stream by processing the voice content of the audio stream using a first machine learning model to generate the text.

16. The device of claim 11, wherein the processor is further configured to determine, based at least in part on at least a portion of the audio stream, whether the voice content corresponds to an interactive voice response system.

17. The device of claim 16, wherein the processor is configured to process the text by:
processing the text using a second machine learning model to generate one or more segments;
extracting a first set of features and a second set of features from the one or more segments using a third machine learning model;
identifying the one or more options using the first set of features; and
identifying an entity based on the second set of features, wherein the entity corresponds to an operator of the interactive voice response system.

18. The device of claim 17, wherein the processor is configured to:
identify one or more input selectors for receiving the selection; and
display the one or more input selectors in association with the one or more options.

19. A computer program product comprising code stored in a tangible computer- readable storage medium, the code comprising:
code to receive, over a communication channel, an audio stream comprising voice content;
code to transcribe the voice content of the audio stream into text;
code to process the text to identify one or more options included in the voice content of the audio stream;
code to display the one or more options;
code to receive a selection corresponding to the one or more options; and
code to transmit, over the communication channel, an indication of the selection.

20. The computer program product of claim 19, wherein the code further comprises:
code to store the one or more options;
code to receive, over the communication channel, a second audio stream comprising a second voice content in response to transmitting the indication of the selection;
code to transcribe the second voice content of the second audio stream into a second text;
code to process the second text to identify one or more second options included in the second voice content of the second audio stream; and
code to display the one or more second options.
